(19) United States
(12) Patent Application Publication
(10) Pub. No.: US 2024/0248694 A1
(43) Pub. Date: Jul. 25, 2024

(54) METHODS AND APPARATUS TO MANAGE A CLOUD DEPLOYMENT

(71) Applicant: VMware LLC, Palo Alto, CA (US)

(72) Inventors: Marin Dzhigarov, Sofia (BG); Ventsyslav Raikov, Sofia (BG); Plamen Peev, Sofia (BG); Thomas Dean Hite, Ponce Inlet, FL (US); Luis Valerio Castillo, Fayetteville, AR (US)

(21) Appl. No.: 18/158,998

(22) Filed: Jan. 24, 2023

(51) Int. Cl. G06F 8/61

(52) U.S. Cl. CPC G06F 8/61

(57) ABSTRACT

Methods, apparatus, systems, and articles of manufacture are disclosed including a system to manage a cloud deployment, the system comprising: at least one memory; programmable circuitry; and machine readable instructions to cause the programmable circuitry to: create a custom resource corresponding to the cloud deployment, the cloud deployment identifiable by cloud credentials of a cloud environment, the custom resource to include an action identifier; generate an infrastructure-as-data to represent the custom resource corresponding to the cloud deployment, the infrastructure-as-data representation to include the cloud credentials; and provide the infrastructure-as-data to an infrastructure adaptor, the infrastructure-as-data to cause performance of an operation corresponding to the action identifier using the cloud deployment.

### FIELD OF THE DISCLOSURE

This disclosure relates generally to cloud computing and, more particularly, to methods and apparatus to manage a cloud deployment.

### BACKGROUND

Cloud environments are sometimes used to execute workloads. Such workloads can be executed using cloud applications. Cloud applications are a collection of compute resources that are coupled by a cloud network. Compute resources are virtual computer systems that are capable of providing computing services. Cloud networks allow cloud applications to create, read, update, and delete resources. Some resources include or are used to implement cloud applications.

### BRIEF DESCRIPTION OF THE DRAWINGS

FIG. 1 is a block diagram of an example cloud environment including an example cloud automation tool configured to manage a cloud infrastructure using an infrastructure adaptor.

FIG. 2 is a schematic illustration of the example cloud automation tool of FIG. 1.

FIG. 3 is a schematic illustration of the infrastructure adaptor of FIG. 1.

FIG. 4 is a schematic illustration of an example blueprint canvas configured to represent cloud resources orchestrated by the cloud automation tool of FIGS. 1 and 2.

FIG. 5 is a schematic illustration of an example custom resource of the cloud automation tool of FIGS. 1 and 2.

FIG. 6 is a timing diagram of example operations to import the custom resource of FIG. 5 into the cloud automation tool of FIGS. 1 and 2.

FIG. 7 is a timing diagram of example operations to perform an action of the custom resource of FIG. 5 using the cloud automation tool of FIGS. 1 and 2 and/or the infrastructure adaptor of FIGS. 1 and 3.

FIGS. 8A and 8B show a flowchart representative of example machine readable instructions and/or example operations that may be executed by example processor circuitry to implement the cloud automation tool of FIGS. 1 and 2.

FIG. 9 is another flowchart representative of example machine readable instructions and/or example operations that may be executed by example processor circuitry to implement the cloud automation tool of FIGS. 1 and 2.

FIG. 10 is a flowchart representative of example machine readable instructions and/or example operations that may be executed by example processor circuitry to implement the infrastructure adaptor of FIGS. 1 and 3.

FIG. 11 is a block diagram of an example processing platform including processor circuitry structured to execute the example machine readable instructions and/or the example operations of FIGS. 8A-10 to implement the cloud automation tool of FIGS. 1 and 2 and/or the infrastructure adaptor of FIGS. 1 and 3.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 8A-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to real world imperfections as will be understood by persons of ordinary skill in the art. For example, “approximately” and “about” may indicate such dimensions may be within a tolerance range of +/−10% unless otherwise specified in the below description. As used herein “substantially real time” refers to an occurrence in a near instantaneous manner recognizing there may be real world delays for computing time, transmission, etc. Thus, unless otherwise specified, “substantially real time” refers to being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

As cloud computing technologies advance, development of cloud services have become increasingly common. Cloud computing, typically, utilizes computing services that are capable of processing substantially more than what may be needed to implement cloud services. For example, a cloud service may be deployed as part of a data center that includes server racks each including a plurality of instances of programmable circuitry. In another example, a cloud application may be deployed on a local network that supports computing operations for a plurality of cloud applications. With demands for cloud computing increasing, incentives for optimizing allocation of computing resources increase.

Cloud computing occurs in response to a deployment of physical resources across a network, virtualizing the physical resources into virtual resources, and provisioning the virtual resources for use across cloud virtual machines, computing services, and/or applications. Cloud automation services reduce creation and deployment complexity of virtual machines, computing services, and applications in a given cloud computing infrastructure. Some such cloud automation services, such as VMware's vRealize Automation (vRA) cloud assembly tool, automate deployment, orchestration, governance, extensibility, and management of resources in a cloud infrastructure.

Examples disclosed herein include methods and apparatus to manage a cloud deployment of a cloud infrastructure. In some disclosed examples, a cloud automation service automates cloud deployment of cloud infrastructures including deploying custom compute resources to create, manage, and orchestrate native and non-native cloud deployments. The cloud-based automation service disclosed herein, imports custom resources using an import service. Custom resources represent virtual compute resources in a non-native cloud deployment. The import service provides the cloud-based automation service with custom resources including predefined action identifiers and schema.

As used herein, an action identifier causes an action-based extensibility (ABX) service of the cloud-based automation service to cause a function-as-a-service (FaaS) to generate an infrastructure-as-data (IaD) representation of a cloud deployment. The FaaS provides the IaD representation of the cloud deployment to an infrastructure adaptor to cause performance of the action corresponding to the action identifier in the non-native cloud deployment. Importing custom resources to the cloud automation service reduces integration complexity of adding support for non-native cloud deployments to the cloud automation service. Additionally, the integration service allows support for resources of non-native cloud deployments without needing users to update the cloud automation service.

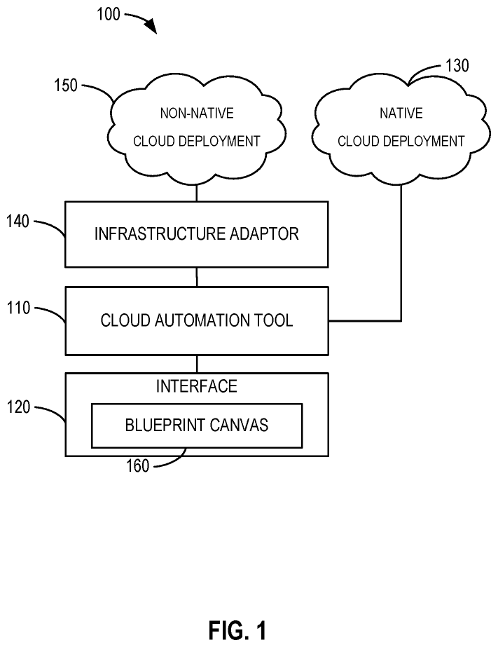

FIG. 1 is a block diagram of an example cloud environment 100 configured to integrate multiple cloud deployments in a single cloud infrastructure. In the example of FIG. 1, the cloud environment 100 includes an example cloud automation tool 110, an example interface 120, an example native cloud deployment 130, an example infrastructure adaptor 140, and an example non-native cloud deployment 150. Deployment, orchestration, governance, extensibility, and management operations of the cloud deployments 130 and 150 are performed by the example cloud automation tool 110. The example cloud deployments 130 and 150 are identifiable by cloud credentials.

The example cloud automation tool 110 is communicatively coupled to the native cloud deployment 130. The example cloud automation tool 110 is communicatively coupled to the non-native cloud deployment 150 through the infrastructure adaptor 140. In the example of FIG. 1, the cloud automation tool 110 may be implemented using VMware's vRealize automation (vRA) cloud assembly tool. Alternatively, the cloud automation tool 110 may be implemented using any other cloud automation service and/or technology suite capable of deploying virtual machines, computing services, and/or applications of a given cloud infrastructure.

The example cloud automation tool 110 represents the cloud environment 100 as a cloud infrastructure. The cloud infrastructure includes native resources, custom resources, and system custom resources that represent operations of the example cloud deployments 130 and 150.

Native resources represent compute resources that have been predefined in the example cloud automation tool 110. Native resources include adaptors that perform operations of the native resource in the native cloud deployment 130. For example, a native resource that represents a virtual machine may include an adaptor to cause a deployment of the native resource in the native cloud deployment 130, such as on a server rack. In examples, a native resource, which represents a web application, may include an adaptor to cause a workload to be executed based on an input from another resource coupled to the cloud network 100.

Developers update, add, and/or delete native resources via the cloud automation tool 110 as a part of product releases. Such a reliance on product releases to modify the native resources, limits users of the cloud automation tool 110 to the native resources of the product release that they are using. Additionally, cloud service providers often release support for new resources much more frequently than the native resources may be updated and/or added.

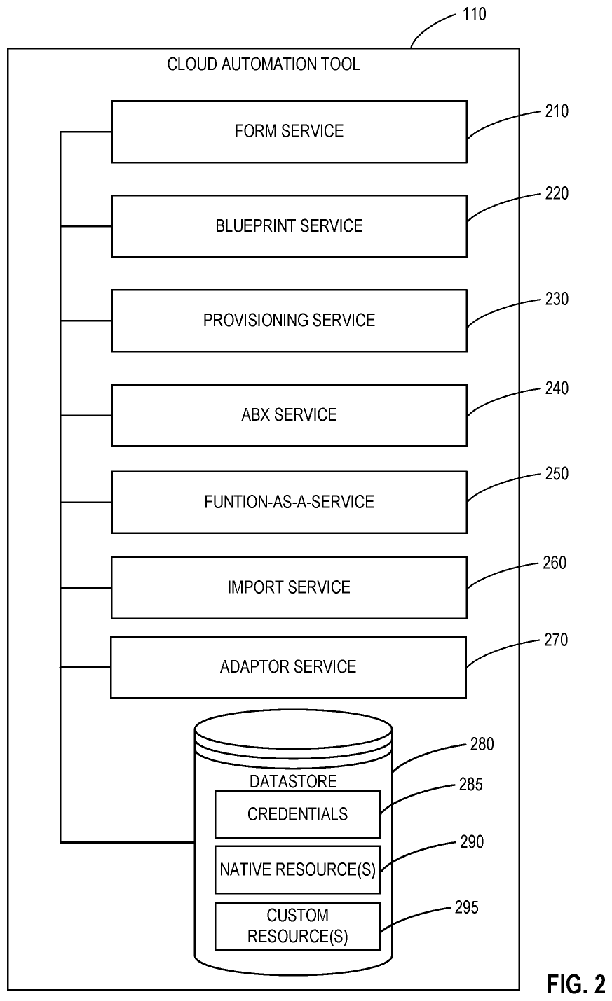

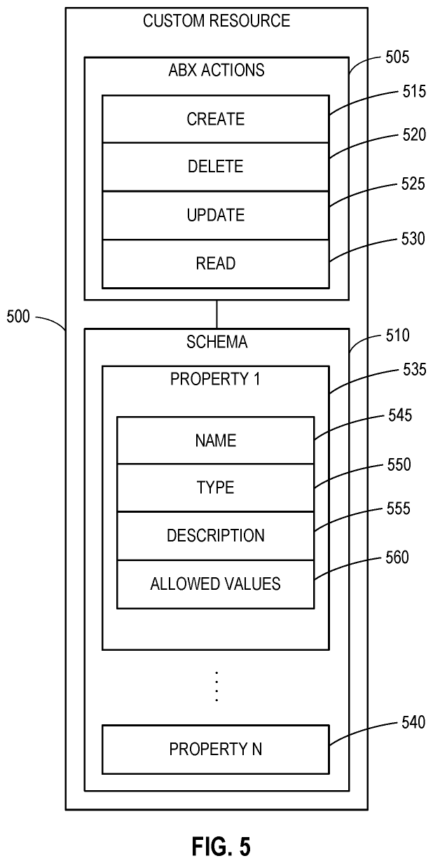

Custom resources allow users to create support for compute resources that are not supported by native resources. Custom resources automate creation of resources based on action identifiers and schema. Action identifiers are a collection of ABX actions that may be performed by an ABX service (e.g., an ABX service 240 of FIG. 2) of the example cloud automation tool 110. The schema is a set of properties that represent support for a resource when the resource is deployed. An example property may include a name, a type, a description, and/or values allowed for that property. An example of a custom resource is illustrated and described in further detail in connection with FIG. 5, below.

The example cloud automation tool 110 allows users to include resources in a cloud infrastructure that are not supported by native resources. To do this, a user creates one or more custom ABX actions and a schema for each custom resource.

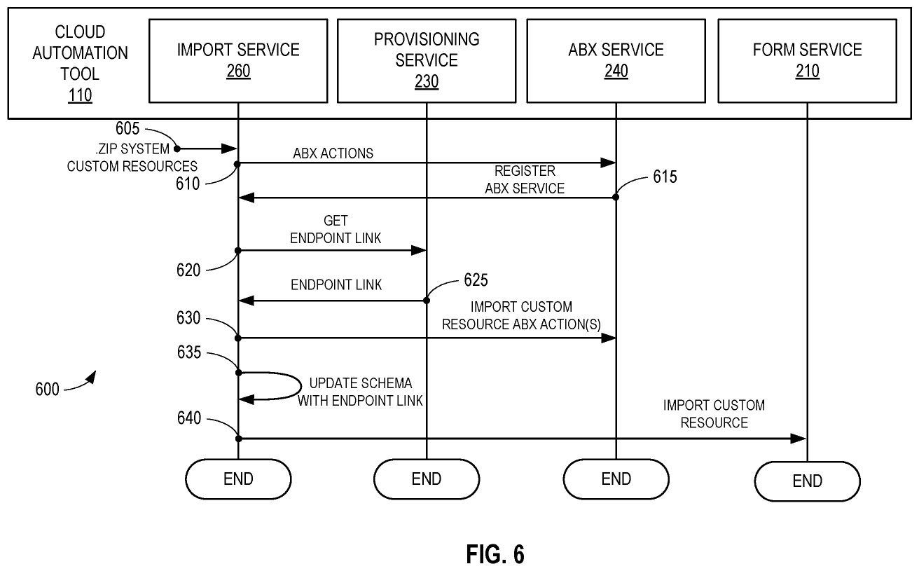

System custom resources are custom resources that the example cloud automation tool 110 imports. An import service of the cloud automation tool 110 (illustrated and discussed in connection with FIGS. 1 and 6, below) imports both ABX actions and a schema to support a compute resource in the non-native cloud deployment 150. System custom resources include action identifiers and a predefined schema. The action identifiers are ABX actions that were created specific to the system custom resource. Action identifiers are capable of causing an ABX service 240 to perform one or more actions of an ABX action. For example, a single action identifier may cause an update and a read operation of a compute resource in the non-native cloud deployment 150. Action identifiers cause the ABX service 240 to preform operations generate an IaD. The IaD, generated in response to an action identifier, represents a resource as created, deleted, updated, and/or modified by the ABX action. The ABX service 240 causes an FaaS to provide the IaD representation of the action to the example infrastructure adaptor 140 to perform an operation on the non-native cloud deployment 150.

The predefined schema is a set of properties configured to represent the system custom resource. System custom resources allow for developers of the cloud automation tool 110 to provide importable custom resources between different software version releases of the example cloud automation tool 110. That is, a future software release of the example cloud automation tool 110 may include a customer-requested native resource. However, until that software release is available, the customer can develop a custom resource for interim use.

The example cloud automation tool 110 automates deploying physical resources across the cloud network 100, virtualizing the physical resources into virtual resources, and provisioning the virtual resources to create the cloud deployments 130 and 150 from the cloud infrastructure. An example embodiment of the cloud automation tool 110 is illustrated and discussed in further detail in connection with FIG. 2, below.

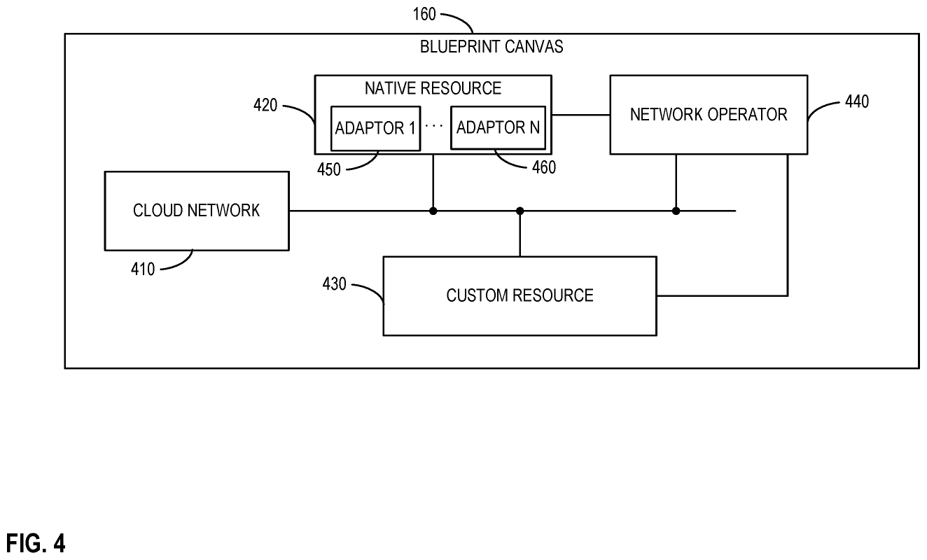

The example interface 120 allows users to assemble the cloud infrastructure for deployment. More specifically, the interface 120 allows users to assemble the cloud infrastructure using an example blueprint canvas 160. The example blueprint canvas is a graphical user interface (GUI) that visualizes the cloud deployments 130 and 150 of the cloud network 100 as a block diagram. The example blueprint canvas is a relatively high-level visual abstraction of the cloud deployments 130 and 150. For example, a cloud administrator may add a resource by dragging, dropping, and connecting a block to the cloud network 100. An example embodiment of the blueprint canvas 160 is illustrated and discussed in further detail in connection with FIG. 4, below.

The example native cloud deployment 130 is a collection of cloud computing resources that include the physical resource implementation of the native and custom resources of the cloud infrastructure. For example, the native cloud deployment 130 may include a plurality of virtual machines, wherein each virtual machine represents a native resource of the cloud infrastructure. In such examples, the plurality of virtual machines may be implemented by one or more computers, servers, processing cores, etc. The example cloud automation tool 110 may modify operations of the resources including the native cloud deployment 130 directly, by implementing an adaptor of a native resource or by using the ABX service 240 to implement actions of a custom resource.

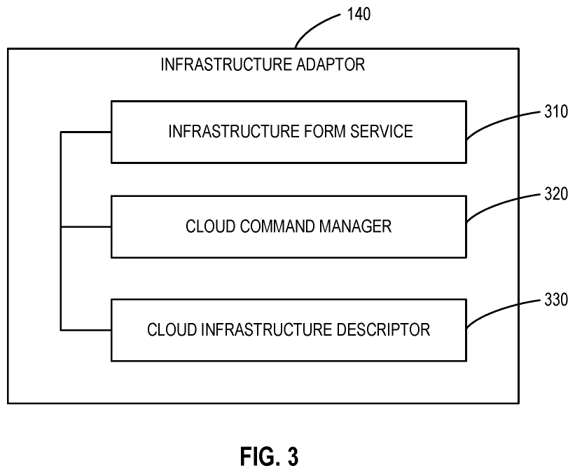

The example infrastructure adaptor 140 is communicatively coupled between the cloud automation tool 110 and the non-native cloud deployment 150. The example infrastructure adaptor 140 receives an IaD representation of a resource of the non-native cloud deployment 150. The example infrastructure adaptor 140 determines cloud commands that modify the non-native cloud deployment 150 to achieve states defined in the IaD representation. For example, the infrastructure adaptor 140 may delete a resource from the non-native cloud deployment 150, when an IaD representation of the resource includes a delete state indicative of the resource being ready for deletion. In such an example, the infrastructure adaptor 140 may determine the state of the resources corresponds to a delete state by comparing a current IaD representation of the cloud deployment to the IaD representation received from the cloud automation tool 110. An example of the infrastructure adaptor 140 is discussed in further detail in connection with FIG. 3, below.

In the example of FIG. 1, the infrastructure adaptor 140 may be implemented using IDEM project's idem open-source tool for cloud configuration management. Alternatively, the example infrastructure adaptor 140 may be implemented using any other suitable cloud management service and/or technology suite capable of generating an IaD representation of cloud infrastructure and/or capable of modifying a cloud deployment using an IaD representation of an operation. In some examples, the IaD includes data specific to results of a performance of an action of the custom resources of the non-native cloud deployment 150.

The example non-native cloud deployment 150 is a collection of cloud computing resources that include the physical resource implementations of the system custom resources of the cloud infrastructure. For example, the native cloud deployment 130 may be a plurality of virtual machines, wherein each virtual machine represents an instance of a system custom resource of the cloud infrastructure. In such an example, the plurality of virtual machines may be implemented by one or more computers, servers, processing cores, etc. The example cloud automation tool 110 may modify operations of the resources including the non-native cloud deployment 150 by calling an action identifier that causes generation of an IaD representation of the action identifier. The example cloud automation tool 110 supplies the IaD representation to the infrastructure adaptor 140.

FIG. 2 is a schematic illustration of the cloud automation tool 110 of FIG. 1 to automate deployment and management of cloud resources of native cloud environments (e.g., the native cloud deployment 130 of FIG. 1) and non-native cloud environments (e.g., the non-native cloud deployment 150 of FIG. 1). The example cloud automation tool 110 of FIG. 2 may be instantiated (e.g., creating an instance of, bring into being for any length of time, materialize, implement, etc.) by processor circuitry such as a central processing unit executing instructions. Additionally or alternatively, the cloud automation tool 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the cloud automation tool circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the cloud automation tool 110 of FIG. 2 may be implemented by microprocessor circuitry executing instructions to implement one or more virtual machines and/or containers.

In the example of FIG. 2, the cloud automation tool 110 includes an example form service 210, an example blueprint service 220, an example provisioning service 230, an example ABX service 240, an example function-as-a-service (FaaS) 250, an example import service 260, an example adaptor service 270, and an example datastore 280. The example datastore 280 includes example credential(s) 285, example native resource(s) 290, and example custom resource(s) 295. The example credential(s) 285 represent the cloud deployments 130 and 150 as cloud credentials.

The example form service 210 manages and orchestrates custom resources. In some examples, a custom resource is available in the blueprint service after the custom resource is identified in the form service 210. For example, one or more of the custom resources 295 may represent deployed resources after being identified in the form service 210. In some examples, identifying custom resources in the form service 210 includes defining locations of operations of the custom resource in the ABX service 240. The locations of operations in the ABX service 240 corresponds to action identifiers of the custom resources 295. ABX actions of the ABX service 240 are identifiable by the endpoint links that the example form service 210 creates in response to the performance of the import service 260. An example creation of endpoint links is further described in connection with FIG. 6, below.

The example form service 210 determines endpoint links that identify locations in the ABX service 240 corresponding to action identifiers of the custom resources 295. For example, the form service 210 creates a new instance of a custom resource in the blueprint service 220 by determining an endpoint link corresponding to ABX actions and a schema corresponding to one of the custom resources 295. In such examples, the form service 210 uses the one of the custom resources 295 to represent the new instance of the custom resource based on an identifier from the blueprint service 220.

The example form service 210 uses the selected endpoint link to perform operations of a custom resource. In some examples, the form service 210 causes the ABX service 240 to perform an operation (e.g., create, delete, update, read, etc.) of a custom resource in the non-native cloud deployment 150. For example, the form service 210 causes performance of an operation to create a custom resource by selecting an endpoint link that identifies operations of the ABX service 240 to create the custom resource in the non-native cloud deployment 150. In other examples, an ABX action identifier identifies operations in the ABX service 240 which construct an ABX action.

The example form service 210 modifies the non-native cloud deployment 150 by determining an operation to be performed corresponds to one of the custom resources 295. In some examples, the example form service 210 causes the ABX service 240 to cause performance of the operation in the non-native cloud deployment 150.

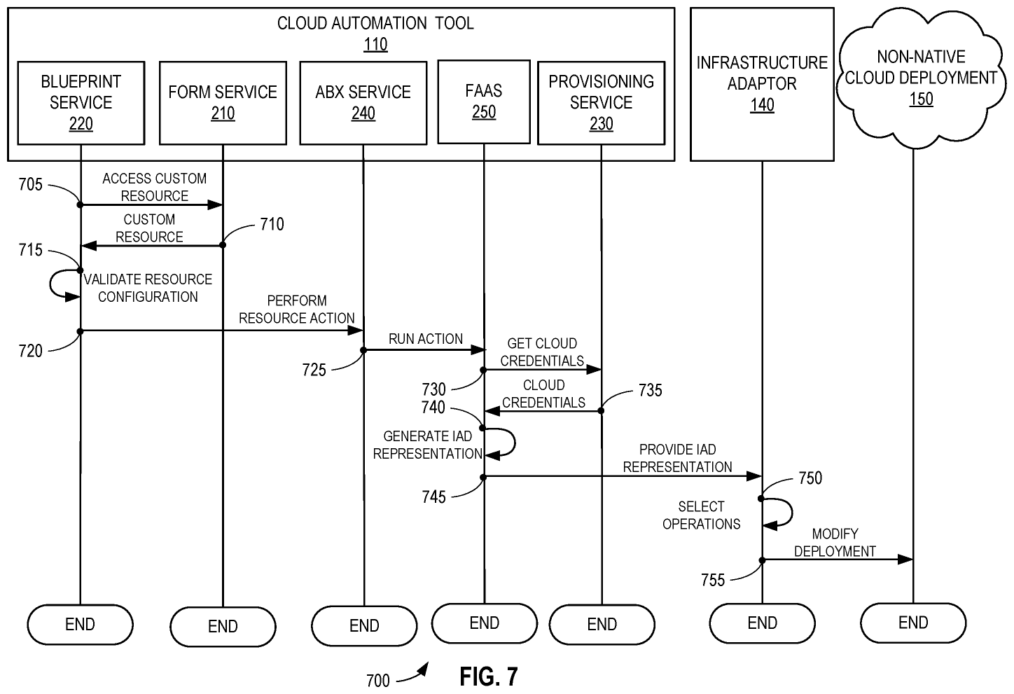

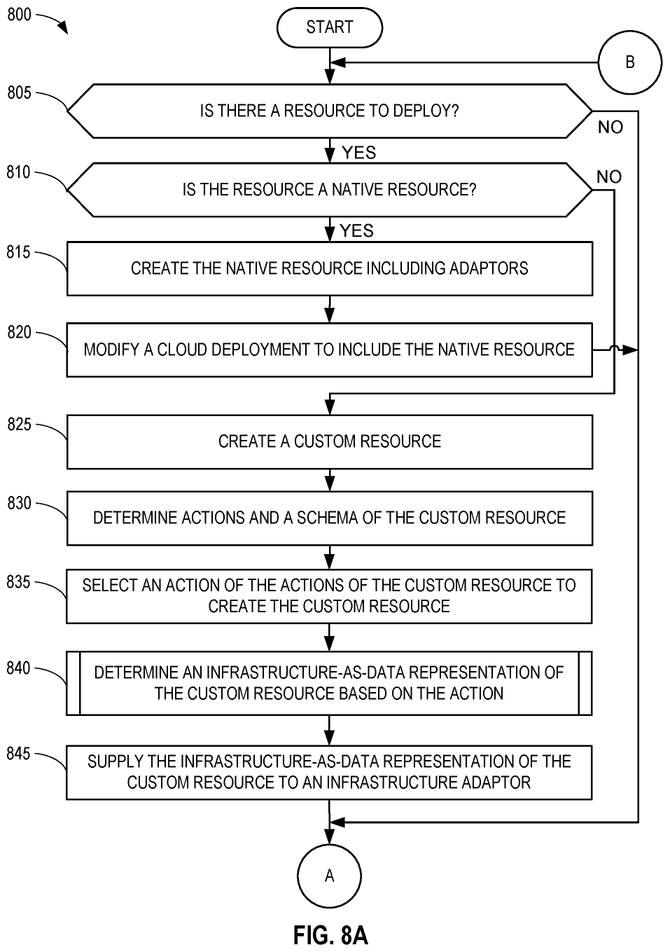

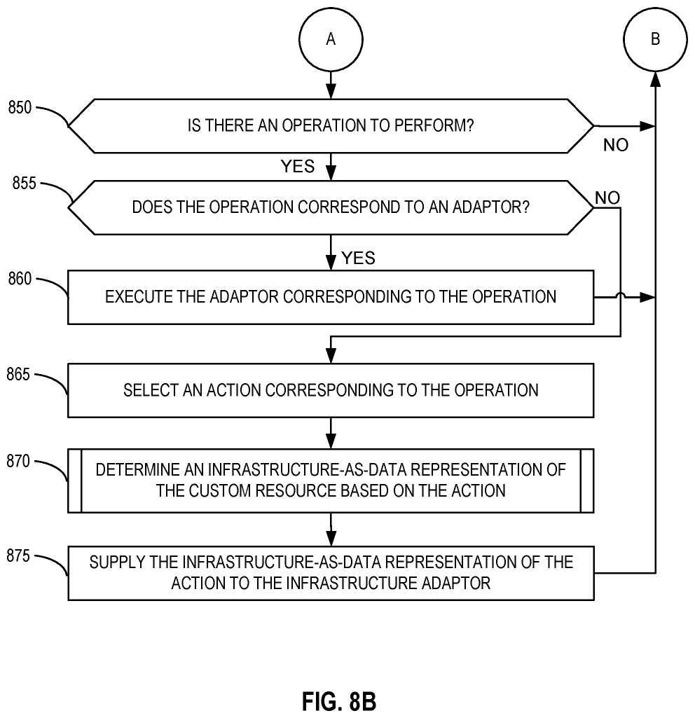

In some examples, the form service circuitry 210 is instantiated by processor circuitry executing form service instructions and/or configured to perform operations such as those represented by the timing diagrams of FIGS. 6 and 7 and the flowchart of FIGS. 8A and 8B.

The example blueprint service 220 integrates the blueprint canvas 160 of FIG. 1 with the cloud automation tool 110. The example blueprint services 220 creates, deletes, and/or modifies instances of resources based on changes to: (1) the blueprint canvas 160, and (2) resources defined in the form service 210 and the provisioning service 230. For example, the blueprint service 220 creates a new instance of one of the custom resources 295 following a user adding the one of the custom resources 295 to the blueprint canvas 160. In such examples, the new instance of the one of the custom resources 295 is defined by the form service 210 prior to the addition of the one of the custom resources 295 to the blueprint canvas 160. In other examples, the blueprint service 220 modifies a pre-defined instance of one of the custom resources 295 based on modifications to the blueprint canvas 160.

The example blueprint service 220 updates the blueprint canvas 160 to reflect an import of the custom resources 295. For example, the blueprint service 220 updates the blueprint canvas 160 to allow users to add one of the custom resources 295 that are imported in response to the operations of FIG. 6.

The example blueprint service 220 supplies the form service 210 with information identifying custom resources included in the blueprint canvas 160. The example blueprint service 220 supplies the provisioning service with information identifying native resources included in the blueprint canvas 160. The example blueprint service 220 may cause an operation to occur to a resource of the blueprint canvas 160 by calling the form service 210. In such examples, the form service 210 may select and/or cause performance of an ABX action in the ABX service 240.

In some examples, the blueprint service 220 generates the information to identify a resource by determining whether the resource in the blueprint canvas 160 is one of the native resources 290 or one of the custom resources 295. In some such examples, the blueprint service 220 generates integration information that specifies integration of a resource in a cloud deployment. For example, the integration information may specify integration of a given resource into a cloud network. In another example, the integration information may specify use of the resource by a network operator (the network operator 440 of FIG. 4), such as a network load balancer.

In some examples, the blueprint service circuitry 220 is instantiated by processor circuitry executing blueprint service instructions and/or configured to perform operations such as those represented by the timing diagram of FIG. 7 and the flowchart of FIGS. 8A and 8B.

The example provisioning service 230 creates, stores, and/or orchestrates usage of the credentials 285 and locations of operations in the adaptor service 270. In some examples, the provisioning service 230 orchestrates access to the native cloud deployment 130 and the non-native cloud deployment 150 based on access requests for the credentials 285.

The example provisioning service 230 receives and/or generates the credentials 285 to identify a cloud location of the native cloud deployment 130 and the non-native cloud deployment 150. The example credentials 285 may be referred to as cloud credentials specific to the cloud deployments 130 and 150. In some examples, the ABX service 240 and/or the adaptor service 270 request(s) the credentials 285 from the provisioning service 230 before performing operations in the native cloud deployment 130 or the non-native cloud deployment 150. For example, the provisioning service 230 orchestrates access to the cloud credentials 285 to prevent potentially conflicting operations from being implemented in the native cloud deployment 130 and/or the non-native cloud deployment 150.

The example provisioning service 230 selects adaptors to perform operations in the native cloud deployment 130 that correspond to an instance of one of the native resources 290. In some examples, the provisioning service 230 selects the adaptors based on an identifier from the blueprint service 220. In some such examples, the identifier corresponds to the one of the native resources 290. The example provisioning service 230 causes the adaptor service 270 to perform operations of the selected adaptors based on a determination of a corresponding operation to perform to the one of the native resources 290.

The example provisioning service 230 modifies the native cloud deployment 130 by determining an operation to be performed corresponds to one of the native resources 290. In some examples, the example provisioning service 230 causes the adaptor service 270 to perform the operation in the native cloud deployment 130.

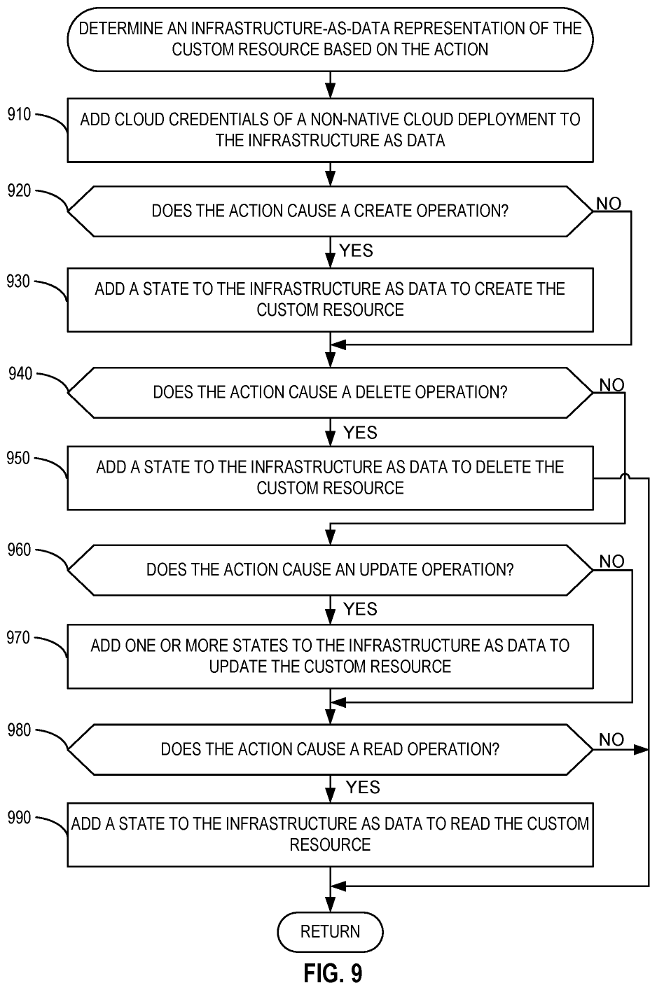

In some examples, the provisioning service circuitry 230 is instantiated by processor circuitry executing provisioning service instructions and/or configured to perform operations such as those represented by the timing diagrams of FIGS. 6 and 7 and the flowchart of FIG. 9.

The example ABX service 240 stores and performs ABX actions of the custom resources 295. The example ABX service 240 is identifiable by an endpoint link from the provisioning service 230. In some examples, the ABX service 240 provides the endpoint link to the form service 210 to perform operations of the custom resources 295. The example form service 210 uses the endpoint link and ABX action identifiers to cause the ABX service 240 to perform ABX actions. For example, an ABX action identifier corresponds to a create operation, in the ABX service 240 that is identified by the endpoint link. In such examples, performing operations at the ABX action identifier in the ABX service 240 causes an instance of one of the custom resources 295 to be created in the non-native cloud deployment 150. The operation of the ABX action, identifiable by the ABX action identifier, may be referred to as a script written in a scripting language (e.g., python). Such a script is stored in the ABX service 240. Alternatively, ABX actions may be stored as part of the datastore 280 in accordance with the teachings disclosed herein. In configurations the datastore 280 stores the ABX actions in a ABX database.

The example form service 210 uses endpoint links and ABX action identifiers to identify operations that cause one or more of a create operation, an update operation, a delete operation, and/or a read operation. In some examples, the form service 210 may include additional ABX action identifiers for custom operations defined by a user of the blueprint canvas 160. For example, a user may add a new custom resource to the custom resources 295 by creating custom ABX actions. The example ABX service 240 determines an operation to be performed based on the endpoint link and the ABX action identifier. For example, the ABX service 240 performs operations to delete an instance of one of the custom resources 295 in response to the form service 210 calling the endpoint link corresponding to a delete action identifier.

The example ABX service 240 may access resource specific data in the form service 210 to perform the operations at an endpoint link. In some examples, the ABX service 240 accesses a schema of an instance of a custom resource to perform an operation at a given endpoint link. For example, the ABX service 240 uses a property as part of operations to update a resource in the non-native cloud deployment 150. In such examples, a schema defines a format in which data is organized in the property. In another example, the ABX service 240 may use the schema to update the data which forms the property of a resource in response to a read operation.

In some examples, the ABX service circuitry 240 is instantiated by processor circuitry executing ABX service instructions and/or configured to perform operations such as those represented by the timing diagrams of FIGS. 6 and 7 and the flowchart of FIG. 9.

The example FaaS 250 integrates usage of the infrastructure adaptor 140 of FIG. 1 with the cloud automation tool 110. The example FaaS 250 generates an IaD representation of an ABX action of the custom resources 295. The example FaaS 250 includes the credentials 285 in the IaD to identify the non-native cloud deployment 150.

In some examples, the ABX service 240 causes the FaaS 250 to add a state to the IaD to cause the infrastructure adaptor 140 to create, delete, update, and/or read an instance of one of the custom resources 295 in the non-native cloud deployment 150. For example, the ABX service 240 causes the FaaS 250 to create a new instance of one of the custom resources 295 by including an identifier of the one of the custom resources 295 with a state that corresponds to creating the resource.

The example FaaS 250 supplies the IaD to the infrastructure adaptor 140 to cause the operation to occur in the non-native cloud deployment 150. For example, the infrastructure adaptor 140 creates a new instance of one of the custom resources 295 in response to an IaD representation of a create action from the FaaS 250.

In some examples, the FaaS circuitry 250 is instantiated by processor circuitry executing FaaS instructions and/or configured to perform operations such as those represented by the timing diagram of FIG. 7 and the flowchart of FIG. 9.

The example import service 260 imports custom resource configurations to establish the custom resources 295. In some examples, the import service 260 may import the custom resource configurations from a file, a compressed file (e.g., ZIP file), a repository, etc. The example import service 260 may register the ABX service 240 by supplying an endpoint link to the provisioning service 230. For example, the import service 260 registers the ABX service 240 in response to an import of custom resource configurations.

The example import service 260 accesses an endpoint link of the ABX service 240 from the provisioning service 230. The example import service 260 supplies ABX actions of the pre-defined custom resources to the ABX service 240 based on the endpoint link. The example import service 260 updates action identifiers of the pre-defined custom resources to include an endpoint link corresponding to the ABX service 240. The example import service 260 creates the custom resources 295 in the datastore 280 including a pre-defined schema and action identifiers that include the endpoint link corresponding to operation in the ABX service 240. An example operation of the import service 260 to import the custom resources 295 is described in further detail in connection with FIG. 6, below.

In some examples, the import service circuitry 260 is instantiated by processor circuitry executing import service instructions and/or configured to perform operations such as those represented by the timing diagram of FIG. 6.

The example adaptor service 270 performs operations corresponding to adaptors of the native resources 290. The example adaptor service 270 causes operations to be performed to the native resources 290 in the native cloud deployment 130. For example, adaptor service 270 causes performance of an operation in the native cloud deployment 130. The example adaptor service 270 supplies the cloud commands (e.g., REST commands) to the native cloud deployment 130 to cause performance of an operation corresponding to an adaptor.

In some examples, the adaptor service circuitry 270 is instantiated by processor circuitry executing adaptor service instructions and/or configured to perform operations such as those represented by the flowchart of FIGS. 8A and 8B.

While an example manner of implementing the cloud automation tool 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example form service 210, the example blueprint service 220, the example provisioning service 230, the example ABX service 240, the example FaaS 250, the example import service 260, the example adaptor service 270, and/or, more generally, the example cloud automation tool 110 of FIGS. 1 and 2, may be implemented by hardware alone or by hardware in combination with software and/or firmware. Thus, for example, any of the example form service 210, the example blueprint service 220, the example provisioning service 230, the example ABX service 240, the example FaaS 250, the example import service 260, the example adaptor service 270, and/or, more generally, the example cloud automation tool 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cloud automation tool 110 of FIGS. 1 and 2 may include one or more elements, processes, and/or devices in addition to, or instead of, those illustrated in FIG. 2, and/or may include more than one of any or all of the illustrated elements, processes and devices.

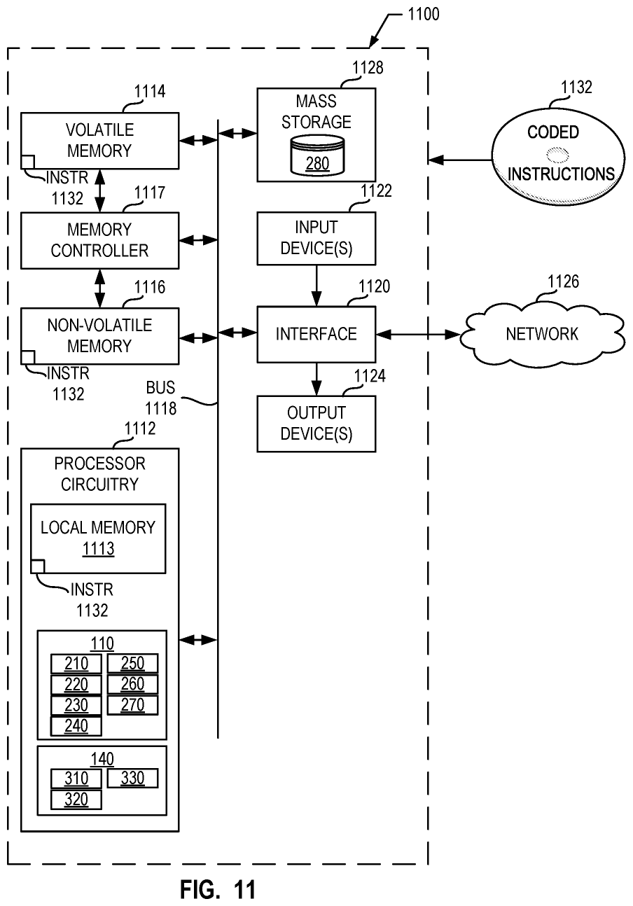

Flowcharts representative of example machine readable instructions, which may be executed to configure processor circuitry to implement the cloud automation tool 110 of FIGS. 1 and 2, is shown in FIGS. 8A, 8B, and 9. The machine readable instructions may be one or more executable program(s) or portion(s) of one or more executable program(s) for execution by processor circuitry, such as the processor circuitry 1112 shown in the example processor platform 1100 discussed below in connection with FIG. 11 and/or the example processor circuitry discussed below in connection with FIGS. 11 and/or 12. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entirety of the program(s) and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 8A, 8B, and 9, many other methods of implementing the example cloud automation tool 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8A-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine-readable medium, and non-transitory machine-readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a block diagram of an example embodiment of the infrastructure adaptor 140 of FIG. 1 to modify states of deployments of system custom resources based on an IaD representation of the non-native cloud deployment 150 of FIG. 1. The infrastructure adaptor 140 of FIG. 3 may be instantiated (e.g., creating an instance of, bring into being for any length of time, materialize, implement, etc.) by processor circuitry such as a central processing unit executing instructions. Additionally or alternatively, the infrastructure adaptor 140 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

In the example of FIG. 3, the infrastructure adaptor 140 includes an example infrastructure form service 310, an example cloud command manager 320, and an example cloud infrastructure descriptor 330.

The example infrastructure form service 310 receives an IaD representation of an operation from the cloud automation tool 110 of FIGS. 1 and 2. The example infrastructure form service 310 parses the IaD to determine states of resources in the non-native cloud deployment 150 of FIG. 1. Using the parsed IaD, the example infrastructure form service 310 determines if there are one or more states to create, delete, update, and/or read a resource in the non-native cloud deployment 150. The example infrastructure form service 310 provides the states to the cloud command manager 320.

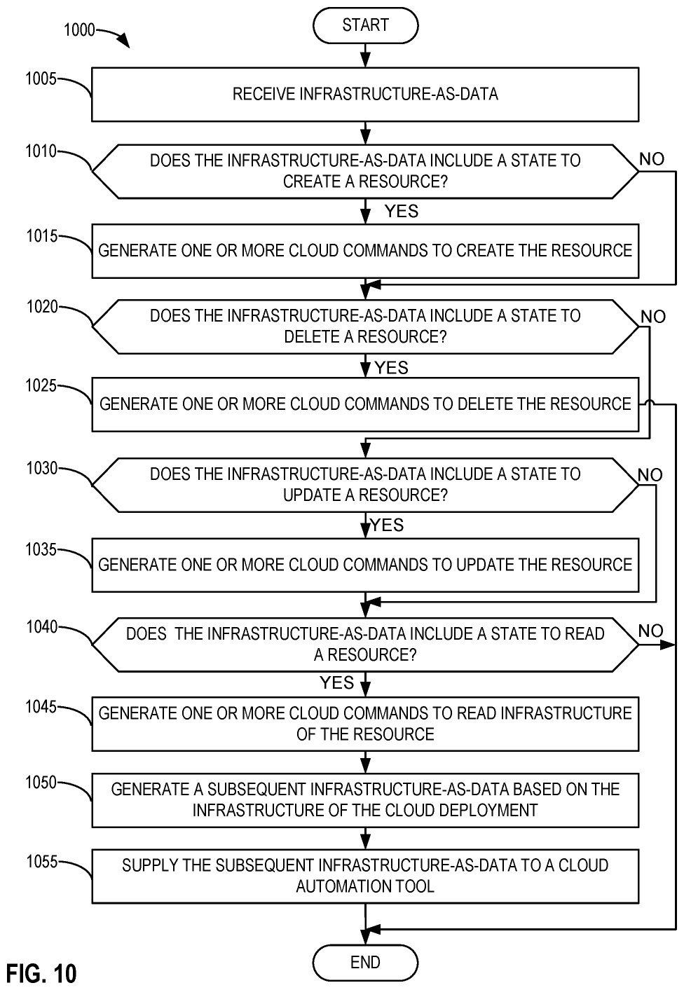

In some examples, the infrastructure provisioning service circuitry 310 is instantiated by processor circuitry executing infrastructure provisioning service instructions and/or configured to perform operations such as those represented by the flowchart of FIG. 10.

The example cloud command manager 320 generates one or more cloud commands based on the states of the IaD. In some examples, the cloud command manager 320 generates cloud environment specific commands to cause a resource (e.g., a virtual machine, a workload, a data store, a memory, a processor, a graphics processing unit, etc.) to perform an operation (e.g., create, delete, update, read, etc.) in the non-native cloud deployment 150. For example, the cloud command manager 320 generates one or more commands to create a custom resource in the non-native cloud deployment in response to a create state in the IaD. The example cloud command manager 320 supplies the one or more cloud commands to a cloud environment. For example, the cloud environment can be identified by credentials included in the IaD, which hosts the non-native cloud deployment 150.

In some examples, the cloud command manager circuitry 320 is instantiated by processor circuitry executing cloud command manager instructions and/or configured to perform operations such as those represented by the flowchart of FIG. 10.

The example cloud infrastructure descriptor 330 generates a subsequent IaD representation of the non-native cloud deployment 150. In some examples, the non-native cloud deployment 150 supplies infrastructure-as-code (IaC) to the infrastructure adaptor 140 in response to a cloud command to read the non-native cloud deployment 150. In some such examples, the cloud infrastructure descriptor 330 converts the IaC representation of the non-native cloud deployment 150 to the subsequent IaD representation. The example cloud infrastructure descriptor 330 supplies the subsequent IaD to the cloud automation tool 110.

In some examples, the cloud infrastructure descriptor circuitry 330 is instantiated by processor circuitry executing cloud infrastructure descriptor instructions and/or configured to perform operations such as those represented by the flowchart of FIG. 10.

FIG. 4 is a schematic illustration of the example blueprint canvas 160 of FIG. 1. In the example of FIG. 4, the blueprint canvas 160 is a GUI representing an example cloud infrastructure such as the cloud environment 100 of FIG. 1. The example blueprint canvas 160 includes an example cloud network 410, an example native resource 420, an example custom resource 430, and an example network operator 440. The blueprint canvas 160 is maintained by the blueprint service 220 of FIG. 2. The example blueprint canvas 160 represents both native resources (e.g., the native resource 420 of FIG. 4) and non-native resources (e.g., the custom resource 430 of FIG. 4). The example network operator 440 performs operations to orchestrate and/or manage the usage of the cloud network 410 by the resources 420 and 430.

The example cloud network 410 communicatively couples the resources 420 and 430 and the network operator 440. In some examples, the cloud network 410 communicatively couples the resources 420 and 430 using a local network. In other examples, the cloud network 410 communicatively couples the resources 420 and 430 using a wireless local area network (WLAN).

The example native resource 420 can represent a compute resource, a data store resource, a memory resource, a network interface resource and/or any other kind of resources of the cloud infrastructure illustrated by the blueprint canvas 160. In the example of FIG. 4, the native resource 420 includes one or more adapters represented as a first example adaptor 450 and a second example adaptor 460. The example adaptors 450 and 460 are configured to cause a deployment of, deletion of, update to, and/or a read of the native resource 420 in a cloud environment. In the example of FIG. 2, the adaptor service 270 of FIG. 2 performs the operations of the adaptors 450 and 460.

For example, the blueprint service 220 of FIG. 2 calls the first adaptor 450 to perform actions to create a deployment of the native resource 420 in a cloud environment. In such examples, the first adaptor 450 may cause a service to partition physical computing resources of a server to deploy the native resource 420 in the native cloud deployment 130.

In other examples, the blueprint service 220 may call the second adaptor 460 to perform actions to update the native resource 420 in a cloud environment. In such examples, the second adaptor 460 may cause a service to increase an amount of physical computing resources allocated to a deployment of the native resource 420 in the native cloud deployment 130.

In yet other examples, the blueprint service 220 may call the second adaptor 460 to delete a deployment of the native resource 420 in a cloud environment. In such examples, the second adaptor causes a service to deallocate physical computing resources which were used to deploy the native resource 420 in the native cloud deployment 130.

The example custom resource 430 is communicatively coupled to the cloud network 410 and the network operator 440. The example custom resource 430 represents resources imported into the cloud automation tool 110 and/or created by a developer. For example, the custom resource 430 represents a custom developed Amazon web service (AWS) resource using ABX actions and a schema. In such an example, the ABX actions of the custom resource 430 may be written by a developer. Alternatively, the ABX actions may be predetermined action identifiers that the cloud automation tool 110 imports using the import service 260 of FIG. 2. The example custom resource 430 may be referred to as a system custom resource when the ABX actions and the schema are predetermined as a result of an import operation of the cloud automation tool 110.

An example of the import operations of the cloud automation tool 110 is illustrated and discussed in connection with FIG. 6, below. An example embodiment of the custom resource 430 is illustrated and discussed in further detail in connection with FIG. 5, below.

The example network operator 440 is coupled to the cloud network 410, the native resource 420, and the custom resource 430. The example network operator 440 is a virtual resource representation of orchestration and/or management operations of the cloud network 410. For example, the network operator 440 may be a load balancer configured to orchestrate communications of the resources 420 and 430 using the cloud network 410. In such examples, the network operator 440 may cause an end user to call one of the adaptors 450 and/or 460, by the blueprint service 220, to update an amount of physical computing resources allocated to the native resource 420. Similarly, the example network operator 440 may call an action identifier of the custom resource 430.

The example network operator 440 may be configured to monitor allocation of computing resources to the resources 420 and 430. For example, the network operator 440 indicates a priority of the native resource 420 as an allocation of physical computing resources to the native resource 420 in the native cloud deployment 130.

In an example operation, a user constructs the blueprint canvas 160 by selecting from a resource catalog, dragging to, and dropping into place resources (e.g., the resources 420 and 430). The resource catalog is a collection of predefined resources, such as the resources 420 and 430. In some examples, users may add a custom resource to the catalog by importing custom resources using the import service 260 and/or developing custom resources using the form service 210. Custom resources, developed using the example form service 210, are published to the blueprint service 220 for use in the blueprint canvas 160. After placing the resources 420 and 430 into the blueprint canvas 160, the user requests the cloud automation tool 110 to deploy the resources 420 and 430 of the blueprint canvas. The cloud automation tool 110 may manage operations (e.g., power on/off reconfigure, scale, delete, etc.) of the resources 420 and/or 430 that have been previously deployed. Such operations after deployment may be referred to as day 2 operations.

FIG. 5 is a schematic illustration of an example custom resource 500 of the cloud automation tool 110 of FIGS. 1 and 2. In the example of FIG. 5, the custom resource 500 includes example ABX actions 505 and an example schema 510. Operations of the example custom resource 500 are represented by the ABX actions 505, which use and/or update information of the schema 510 to perform operations on a deployment of the custom resource 500.

The example ABX actions 505 are actions performed by the ABX service 240 of FIG. 2 to perform operations using one of the cloud deployments 130 or 150 of FIG. 1. In the example of FIG. 5, the ABX actions 505 include an example create action identifier 515, an example delete action identifier 520, an example update action identifier 525, and an example read action identifier 530. The example ABX actions 505 are operations of the ABX service 240 that perform corresponding operations in one of the native cloud deployment 130 or the non-native cloud deployment 150.

The ABX actions 505 correspond to operations in a non-native deployment (e.g., the non-native cloud deployment 150 of FIG. 1) when the ABX actions 505 are imported, such that the custom resource 500 may be considered a system custom resource. When the ABX actions 505 are imported, the action identifiers 515, 520, 525, and 530 result in the cloud automation tool 110 creating an IaD in response to the operation(s) of one or more of the ABX actions 505. In such examples, the cloud automation tool 110 supplies the generated IaD to the infrastructure adaptor 140. The infrastructure adaptor 140 determines operations of the non-native cloud deployment 150 that results in an IaD representation of the non-native cloud deployment 150 having states that are approximately the same as states of the IaD representation from the cloud automation tool 110.

Although the example action identifiers 515, 520, 525, and 530 are illustrated in connection with FIG. 5, the ABX actions 505 may include action identifiers that include operations of one or more of the example action identifiers 515, 520, 525, and 530 in a single set of operations of the ABX service 240. Alternatively, the ABX actions 505 may include alternate actions that may be performed by the ABX service 240. For example, the ABX actions 505 may include a reset action identifier to cause the ABX service 240 to perform operations to restore a deployment of the custom resource 500 to a predetermined state.

The example schema 510 is a set of properties that represent a format of data of the custom resource 500. In the example of FIG. 5, the schema 510 includes a first example property 535 and a second example property 540. Alternatively, the example schema 510 may include any number of properties that represent the format of the data of the custom resource 500.

The first example property 535 includes data to specify an example name 545, an example data type 550, an example description 555, and example allowed values 560. The example name 545 is a name of the first example property 535 that may be called as an input to and/or an output of the ABX service 240. The example data type 550 specifies a type of data that may be used as input and/or output in performing one of the ABX actions 505.

The example description 555 describes the first property 535. For example, the description 555 may represent a current state of and/or a value representative of the first property 535. The example allowed values 560 specify possible values of the description 555. For example, the allowed values 560 may be a range of values to which the description 555 may be set. In other examples, the allowed values 560 may be a list of potential states of the description 555. In such examples, the list of potential states may include an indication for an active state or an inactive state.

FIG. 6 is a timing diagram of example operations 600 to import the custom resource 500 of FIG. 5 into the cloud automation tool 110 of FIGS. 1 and 2. The example operations 600 begin at a first time 605 at which the import service 260 of FIG. 2 imports system custom resources. In some examples, the import service 260 receives a file path to a folder that includes a plurality of system custom resources (e.g., in one or more .ZIP files). In some such examples, the folder includes ABX identifiers (e.g., the action identifiers 515, 520, 525, 530 of FIG. 5) and properties (e.g., the properties 535 and 540 of FIG. 5) corresponding to ABX actions and schema that form one or more system custom resources.

At a second time 610, the example import service 260 parses the system custom resources from the first time 605 and provides ABX actions to the ABX service 240 of FIG. 2.

At a third time 615, the cloud automation tool 110 registers the ABX service 240 in the import service 260. The example provisioning service 230 generates endpoint link(s) that identify operations of the ABX service 240. For example, the ABX actions 505 of FIG. 5 of the custom resource 500 are identifiable in the ABX service 240 by a corresponding endpoint link. Alternatively, the example cloud automation tool 110 may register the ABX service 240 in the provisioning service 230 as a part of a setup/initialization process of the cloud automation tool 110.

During the registration of the third time 615, the ABX service 240 may generate and/or store endpoint link(s) and ABX action identifiers to individually identify each ABX action. The ABX action identifiers identify operations of ABX actions in the ABX service 240. The example import service 260 receives ABX action identifiers from the ABX service 240 to identify locations of operations that correspond to each of the ABX actions being imported.

At a fourth time 620, the example import service 260 gets and/or requests the endpoint link from the provisioning service 230. At a fifth time 625, the example provisioning service 230 provides the endpoint link, that identifies the ABX service 240, to the import service 260.

At a sixth time 630, the example import service 260 imports ABX actions of the custom resource from a location in the ABX service 240 identified by the endpoint link from the fifth time 625. For example, the import service 260 begins to populate the ABX actions 505 and the schema 510 of FIG. 5 using ABX actions identified by the endpoint link.

At a seventh time 635, the example import service 260 updates the schema 510 identified in the ABX actions 505 from the sixth time 630 to include the endpoint link from the fifth time 625. Following the seventh time 635, the example schema 510 points to an instance of the ABX actions 505 of the sixth time 630 at the endpoint identified in the endpoint link from the fifth time 625.

At an eighth time 640, the example import service 260 imports the custom resource including the ABX actions 505 from the sixth time 630 and the schema 510 from the seventh time 635 to the form service 210. After the eighth time 640, a user may select to create an instance of the custom resource, which was imported at the eighth time 640, by selecting, dragging, and dropping the custom resource onto a graphical user interface (GUI) object or control that represents the example blueprint canvas 160 of FIGS. 1 and 4.

FIG. 7 is a timing diagram of example operations 700 to perform an action of the custom resource 500 of FIG. 5 in the non-native cloud deployment 150 of FIG. 1. The example operations 700 begin at a first time 705 at which the example blueprint service 220 of FIG. 2 accesses a custom resource in the form service 210 of FIG. 2. For example, the blueprint service 220 requests information of a specific custom resource when a user selects and places a custom resource in the blueprint canvas 160 of FIGS. 1 and 4.

At a second time 710, the example form service 210 provides the custom resource to the blueprint service 220. For example, the form service 210 provides the schema 510 of FIG. 5 to the blueprint service 220 to show the properties 535 and 540 of FIG. 5 of an instance of the custom resource 500.

At a third time 715, the example blueprint service 220 validates the resource configuration from the form service 210.

At a fourth time 720, the example blueprint service 220 causes the form service 210 to perform an action of the custom resource 500. For example, the blueprint service 220 causes generation of an IaD which causes creation of a deployment of the custom resource in the non-native cloud deployment 150. At the fourth time 720, the form service 210 may determine the ABX action identifier corresponding to an ABX action identified by the blueprint service 220.

At a fifth time 725, the example ABX service 240 performs the ABX action, specified at the fourth time 720, by running the ABX action using the FaaS 250 of FIG. 2. In some examples, the FaaS 250 performs a series of operations to cause performance of an ABX action.

At a sixth time 730, the example FaaS 250 requests cloud credentials of the non-native cloud deployment 150 from the example provisioning service 230 of FIG. 2. At a seventh time 735, the provisioning service 230 supplies the cloud credentials, requested at the sixth time 730, to the FaaS 250.

At an eighth time 740, the example FaaS 250 generates an IaD representation of the custom resource 500. For example, the FaaS 250 may generate an IaD representation of the non-native cloud deployment 150 with a new resource listed and a corresponding create state. In such an example, the addition of the custom resource corresponds to performance of a create action identifier. In another example, the FaaS 250 may remove an instance of the custom resource 500 from an IaD representation of the non-native cloud deployment 150. In such other examples, removal of the instance of the custom resource 500 from the IaD representation corresponds to performance of a delete action identifier.

At a ninth time 745, the example FaaS 250 provides the IaD generated at the eighth time 740 to the infrastructure adaptor 140 of FIGS. 1 and 3. At a tenth time 750, the example infrastructure adaptor 140 selects operations of the non-native cloud deployment 150 to implement the IaD from the ninth time 745. For example, the infrastructure adaptor 140 compares states of the properties of the IaD representation from the ninth time 745 to a current IaD representation of the non-native cloud deployment 150. In such examples, the infrastructure adaptor 140 selects operations to create, update, read, and/or delete properties of a deployment of the custom resource 500 in the non-native cloud deployment 150.

At an eleventh time 755, the example infrastructure adaptor 140 supplies the operations, from the tenth time 750, to the non-native cloud deployment 150. Following the eleventh time 755, the example cloud infrastructure of the custom resource 500 from the first time 705 in the non-native cloud deployment 150 should be equal to the IaD representation at the ninth time 745.

FIGS. 8A and 8B form a flowchart representative of example machine readable instructions and/or example operations 800 that may be executed and/or instantiated by processor circuitry to implement the cloud automation tool 110 of FIGS. 1 and 2. The machine-readable instructions and/or the operations 800 of FIGS. 8A and 8B begin at block 805, at which the example blueprint service 220 of FIG. 2 determines if there is a new instance of a resource. (Block 805). In some examples, the blueprint service 220 determines there is a resource to deploy based on a user requesting for a blueprint canvas (e.g., the blueprint canvas 160 of FIGS. 1 and 5) to be deployed. Such a blueprint canvas may include one or more instances of the resources 290 and/or 295 of FIG. 2. In other examples, the blueprint service 220 deploys a new resource by determining if the resource has been previously deployed.

If there is not a resource to deploy (Block 805 returns a result of NO), control advances to block 850 of FIG. 8B. Otherwise, the blueprint service 220 determines there is a resource to deploy (e.g., Block 805 returns a result of YES), the blueprint service 220 determines if the resource is a native resource (e.g., the native resources 290). In some examples, the blueprint service 220 determines if the resource is one of the native resources 290 based on a determination that there are adaptors (e.g., the adaptors 450 and 460 of FIG. 4) corresponding to the resource.

If the example blueprint service 220 determines the resource is a native resource (e.g., Block 810 returns a result of YES), the blueprint service 220 creates the native resource 420 of FIG. 4 including adaptors 450 and 460 of FIG. 4 in the provisioning service 230 of FIG. 2. (Block 815). In some examples, the blueprint service 220 supplies integration information to the provisioning service 230 to specify integration into a cloud network (e.g., the cloud network 410 of FIG. 4). In such examples, the blueprint service 220 generates the integration information based on an integration of the native resource 420 in the blueprint canvas 160.

The example provisioning service 230 modifies a cloud deployment to include the native resource 420. (Block 820). In some examples, the provisioning service 230 initiates execution of an adaptor of the native resource 420 in the adaptor service 270 of FIG. 2 to deploy the native resource 420 in the native cloud deployment 130 of FIG. 1.

If the blueprint service 220 determines the resource is not a native resource (e.g., Block 810 returns a result of NO), the blueprint service 220 creates a custom resource 430 in the form service 210. (Block 825). The example form service 210 determines actions (e.g., the ABX actions 505 of FIG. 5) and a schema (e.g., the schema 510 of FIG. 5) of the custom resource. (Block 830). In some examples, the form service 210 determines the ABX actions 505 and the schema 510 of the custom resource based on a configuration determined by the import service 260 of FIGS. 2 and 6. In such examples, the import service 260 determines the configuration in response to the cloud automation tool 110 performing the operations 600 of FIG. 6.

The example form service 210 selects an action of the actions of the custom resource 430 to create the custom resource 430 in the non-native cloud deployment 150. (Block 835). In some examples, the form service 210 selects the action by determining an endpoint link that corresponds to a create operation in the ABX service 240 of FIGS. 2, 6, and 7.

The example cloud automation tool 110 generates an infrastructure-as-data representation of the custom resource 430 based on the action. (Block 840). Example instructions to generate the infrastructure-as-data representation of the custom resource 430 based on the action are described in connection with FIG. 9, below.

The example FaaS 250 of FIGS. 2 and 7 supplies the infrastructure-as-data representation of the custom resource 430 to the infrastructure adaptor 140 of FIGS. 1, 3, and 7. (Block 845). In some examples, the FaaS 250 may supply the infrastructure-as-data representation of the custom resource 430 to the infrastructure adaptor 140 to cause an operation to be performed in the non-native cloud deployment 150. For example, the operations 745, 750, and 755 of FIG. 7.

Turning to FIG. 8B, the example blueprint service 220 determines if there is an operation to perform. (Block 850). In some examples, the form service 210 generates an operation to be performed to read a resource periodically or in response to an action on the cloud network. For example, the form service 210 may cause a read operation of one or more of the resources 420 and/or 430 in response to a read event on the cloud network 410.

If the example blueprint service 220 determines there is not an operation to perform (e.g., Block 850 returns a result of NO), control returns to Block 805 in FIG. 8A. If the blueprint service 220 determines there is an operation to perform (e.g., Block 850 returns a result of YES), the example blueprint service 220 determines if the operation corresponds to an adaptor. (Block 855).

If the example blueprint service 220 determines the operation corresponds to an adaptor (e.g., Block 855 returns a result of YES), the example adaptor service 270 executes the adaptor corresponding to the operation. (Block 860). In some examples, the adaptor service 270 performs operations included in an adaptor (e.g., one of the adaptors 450 or 460) that represents the operation. For example, an operation corresponding to the first adaptor 450 may cause the adaptor service 270 to perform operations to update values of the native resource 420 in the native cloud deployment 130.

If the example form service 210 determines the operation does not correspond to an adaptor (e.g., Block 855 returns a result of NO), the form service 210 selects an action corresponding to the operation. (Block 865). In some examples, the form service 210 determines the action corresponding to the operation based the custom resource corresponding to the operation. For example, the form service 210 determines an endpoint location of an ABX action in the ABX service 240 of FIGS. 2, 6, and 7 from the action identifiers (e.g., the action identifiers 515, 520, 525, and 530 of FIG. 5) included in the custom resource corresponding to the action.

The example cloud automation tool 110 generates an infrastructure-as-data representation of the custom resource 430 based on the action. (Block 870). Example instructions that may be used to implement Block 870 are described below in connection with FIG. 9. The example FaaS 250 of FIGS. 2 and 7 supplies the infrastructure-as-data representation of the custom resource 430 to the infrastructure adaptor 140 of FIGS. 1, 3, and 7. (Block 875). Control returns to Block 805.

Although example processes are described with reference to the flowchart illustrated in FIGS. 8A and 8B, many other methods of implementing the cloud automation tool 110 may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 9 is a flowchart representative of example machine readable instructions and/or example operations that may be used to implement Block 840 of FIG. 8A and Block 870 of FIG. 8B. The instructions and/or operations of FIG. 9 may be executed and/or instantiated by processor circuitry to generate an infrastructure-as-data representation of an action. The machine-readable instructions and/or the operations of FIG. 9 begin at block 910, at which the example FaaS 250 of FIGS. 2 and 7 adds cloud credentials of a non-native cloud deployment (e.g., the non-native cloud deployment 150 of FIG. 1) to the infrastructure-as-data. In some examples, the FaaS 250 requests and receives the cloud credentials from the provisioning service 230 of FIGS. 2, 6, and 7.

The example ABX service 240 of FIGS. 2, 6, and 7 determines if the action causes a create operation. (Block 920). For example, an endpoint link in the ABX service 240 causes the FaaS 250 to create an instance of the custom resource. If the example ABX service 240 determines that the action causes a create operation (e.g., Block 920 returns a result of YES), the example FaaS 250 includes a state in the infrastructure-as-data to create the custom resource. (Block 930). In some examples, the FaaS 250 adds an identifier of the custom resource 500 to the infrastructure-as-data with a create state identifying the custom resource as a new resource. In such examples, the ABX service 240 provides the FaaS 250 with the identifier corresponding to the custom resource from the schema 510 of FIG. 5. Alternatively, the ABX service 240 may use a create state to perform both create and update operations. In such examples, the ABX service 240 des not differentiate between create and update operations when calling the infrastructure adaptor 140 (IDEM). Instead, the form service 210 is configured to reset the resource to an original state when the resource is present with the supplied representation. In such examples, the infrastructure adaptor 140 creates an instance of a resource if it does not exist or updates an existing resource if it already exists.

If the example ABX service 240 determines that the action does not cause a create operation (e.g., Block 920 returns a result of NO) or the FaaS 250 creates the custom resource (e.g., Block 930 completes), the ABX service 240 determines if the action causes a delete operation. (Block 940). If the example ABX service 240 determines that the actions does cause a delete operation (e.g., Block 940 returns a result of YES), the FaaS 250 adds a state to the infrastructure-as-data to delete the custom resource. (Block 950). In some examples, the FaaS 250 adds an identifier of the custom resource 500 to the infrastructure-as-data with a delete state.

If the example ABX service 240 determines that the action does not cause a delete operation (e.g., Block 940 returns a result of NO), the ABX service 240 determines if the action causes an update operation. (Block 960). If the example ABX service 240 determines that the actions does cause an update operation (e.g., Block 960 returns a result of YES), the FaaS 250 adds one or more states to the infrastructure-as-data to update the custom resource. (Block 970). In some examples, the FaaS 250 adds one or more property names (e.g., the name 545 of the first property 535) and an updated state for each property to the infrastructure-as-data. In such examples, the ABX service 240 supplies the FaaS 250 with the one or more property names and the updated state for each property. For example, the FaaS 250 adds a first name corresponding to a first state and a second name corresponding to a second state to the infrastructure-as-data to modify the properties corresponding to the first name and the second name. In such examples, the first state and/or the second state may modify the type 550 of FIG. 5, the description 555 of FIG. 5, and/or the allowed values 560 of FIG. 5 of the properties corresponding to the first name or the second name. In other examples, the FaaS 250 adds the identifier corresponding to the custom resource and a reference state of the custom resource to the IaD. For example, the FaaS 250 adds the identifier of the custom resource and a return state to the infrastructure-as-data. In such examples, the return state corresponds to the initial state of the custom resource as though the custom resource is initialized to.

If the example ABX service 240 determines that the action does not cause an update operation (e.g., Block 960 returns a result of NO) or the FaaS 250 updates the custom resource (e.g., Block 970 completes), the ABX service 240 determines if the action causes a read operation. (Block 980). If the ABX service 240 determines that the actions does cause a read operation (e.g., Block 980 returns a result of YES), the FaaS 250 adds a state to the infrastructure-as-data to read the custom resource. (Block 990). In some examples, the FaaS 250 adds an identifier of the custom resource 500 to the infrastructure-as-data with a read state to perform a read operation of the custom resource in the non-native cloud deployment 150. In such examples, the FaaS 250 receives a subsequent infrastructure-as-data from the infrastructure adaptor 140 of FIGS. 1 and 3. The example FaaS 250 may compare the subsequent infrastructure-as-data to a previously generated infrastructure-as-data to verify performance of a previous action in the non-native cloud deployment 150. The instructions of FIG. 9 return infrastructure-as-data resulting from Blocks 910, 930, 950, 970, and/or 990 to the cloud automation tool 110.

Although example processes are described with reference to the flowchart illustrated in FIG. 9, many other methods of generating an infrastructure-as-data representation of an action may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 10 is a flowchart representative of example machine readable instructions and/or example operations of the infrastructure adaptor 140 of FIGS. 1, 3, and 7 that may be executed and/or instantiated by processor circuitry to perform operations to a non-native cloud deployment based on an infrastructure-as-data representation of an action. The machine-readable instructions and/or the operations 1000 of FIG. 10 begin at block 1005, at which the example infrastructure provisioning service 310 of FIG. 3 receives infrastructure-as-data. (Block 1005). In some examples, the infrastructure form service 310 receives the infrastructure-as-data from the cloud automation tool 110 of FIGS. 1, 2, 6, and 7. For example, the infrastructure form service 310 receives an infrastructure-as-data from the FaaS 250 of FIGS. 2 and 7 after Block 845 of FIG. 8A and/or Block 875 of FIG. 8B.

The example infrastructure form service 310 determines if the infrastructure-as-data includes a state to create a resource. (Block 1010). In some examples, the infrastructure form service 310 parses the infrastructure-as-data to determine if there is a resource identifier corresponding to a create state. For example, the infrastructure form service 310 determines there is a state to create a resource if the infrastructure-as-data is generated at Block 930 of FIG. 9.

If the infrastructure form service 310 determines there is a state to create a resource in the infrastructure-as-data (e.g., Block 1010 returns a result of YES), the example cloud command manager 320 of FIG. 3 generates one or more commands to create the resource. (Block 1015). In some examples, the cloud command manager 320 generates cloud commands that are specific to a cloud environment corresponding to a cloud deployment of the resource. For example, the cloud command manager 320 generates commands to create the resource that are specific to the non-native cloud deployment 150 of FIG. 1.

If the infrastructure form service 310 determines there is not a state to create a resource in the infrastructure-as-data (e.g., Block 1010 returns a result of NO) or the cloud command manager 320 generates commands to create the resource (e.g., Block 1015 is performed), the infrastructure form service 310 determines if the infrastructure-as-data includes a state to delete a resource. (Block 1020). In some examples, the infrastructure form service 310 parses the infrastructure-as-data to determine if there is a resource identifier corresponding to a delete state. For example, the infrastructure form service 310 determines there is a state to delete a resource if the infrastructure-as-data is generated at Block 950 of FIG. 9.

If the infrastructure form service 310 determines there is a state to delete a resource in the infrastructure-as-data (e.g., Block 1020 returns a result of YES), the example cloud command manager 320 generates one or more cloud commands to delete the resource. (Block 1025). In some examples, the cloud command manager 320 generates commands to delete the resource that are specific to the non-native cloud deployment 150. Example cloud commands are described above in connection with FIG. 3. In the example of FIG. 10, after block 1025, control ends.

If the example infrastructure form service 310 determines there is not a state to delete a resource in the infrastructure-as-data (e.g., Block 1020 returns a result of NO), the infrastructure form service 310 determines if the infrastructure-as-data includes a state to update a resource. (Block 1030). In some examples, the infrastructure form service 310 parses the infrastructure-as-data to determine if there are one or more states corresponding to an update. For example, the infrastructure form service 310 determines there is one or more updates to the resource if the infrastructure-as-data is generated at Block 970 of FIG. 9.

If the example infrastructure form service 310 determines there is a state to update a resource in the infrastructure-as-data (e.g., Block 1030 returns a result of YES), the example cloud command manager 320 generates one or more cloud commands to update the resource. (Block 1035). In some examples, the cloud command manager 320 generates cloud commands to update properties of the resource (e.g., the properties 535 and 540 of FIG. 5) that are specific to the non-native cloud deployment 150.

If the example infrastructure form service 310 determines there is not a state to update a resource in the infrastructure-as-data (e.g., Block 1030 returns a result of NO) or the cloud command manager 320 generates cloud commands to update the resource (e.g., Block 1035 is performed), the infrastructure form service 310 determines if the infrastructure-as-data includes a state to read a resource. (Block 1040). In some examples, the infrastructure form service 310 parses the infrastructure-as-data to determine if there is a resource identifier corresponding to a read state. For example, the infrastructure form service 310 determines there is a state to delete a resource if the infrastructure-as-data is generated at Block 990 of FIG. 9. If the infrastructure form service 310 determines the infrastructure-as-data does not include a state to read a resource (Block 1040 returns a result of NO), control ends.

If the example infrastructure form service 310 determines there is a state to read a resource in the infrastructure-as-data (e.g., Block 1040 returns a result of YES), the example cloud command manager 320 generates one or more cloud commands to read the infrastructure of the resource. (Block 1045). In some examples, the cloud command manager 320 generates cloud commands to cause a read of properties of the resource that are specific to the non-native cloud deployment 150.

The example cloud infrastructure descriptor 330 generates a subsequent infrastructure-as-data based on the infrastructure of the cloud deployment. (Block 1050). In some examples, the cloud infrastructure descriptor 330 determines states of the infrastructure of the resource in response to the commands generated at Block 1045. The example cloud infrastructure descriptor 330 supplies the subsequent infrastructure-as-data to the cloud automation tool 110 of FIGS. 1, 2, 6, and 7. (Block 1055).

If the infrastructure form service 310 determines there is not a state to read a resource in the infrastructure-as-data (e.g., Block 1040 returns a result of NO) or the cloud infrastructure descriptor 330 supplies the subsequent infrastructure-as-data to the cloud automation tool 110 (e.g., Block 1055 is performed).The example operations and/or instructions of FIG. 10 end.

Although example processes are described with reference to the flowchart illustrated in FIG. 10, many other methods of performing operations in a non-native cloud deployment based on an infrastructure-as-data representation of an action may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 11 is a block diagram of an example processor platform 1100 structured to execute and/or instantiate the machine readable instructions and/or the operations of FIGS. 8A-10 to implement the cloud automation tool of FIGS. 1, 2, 6, and 7. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a digital video recorder, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example form service 210 of FIGS. 2, 6, and 7, the example blueprint service 220 of FIGS. 2 and 7, the example provisioning service 230 of FIGS. 2, 6, and 7, the example ABX service 240 of FIGS. 2, 6, and 7, the example FaaS 250 of FIGS. 2 and 7, the example import service 260 of FIGS. 2 and 6, the example adaptor service 270 of FIG. 2, and/or, more generally, the example cloud automation tool 110 of FIGS. 1, 2, 6, and 7. Additionally, the processor circuitry 1112 implements the example infrastructure form service 310 of FIG. 3, the example cloud command manager 320 of FIG. 3, the example cloud infrastructure descriptor 330 of FIG. 3, and/or more generally the infrastructure adaptor 140 of FIGS. 1, 3, and 7.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In the example of FIG. 11, the mass storage device 1128 includes the datastore 280 of FIG. 2.

The machine-readable instructions 1132, which may be implemented by the machine-readable instructions of FIGS. 8A-10 may be stored in the mass storage device 1128, in the volatile memory 1114, in the non-volatile memory 1116, and/or on a removable non-transitory computer readable storage medium such as a CD or DVD.

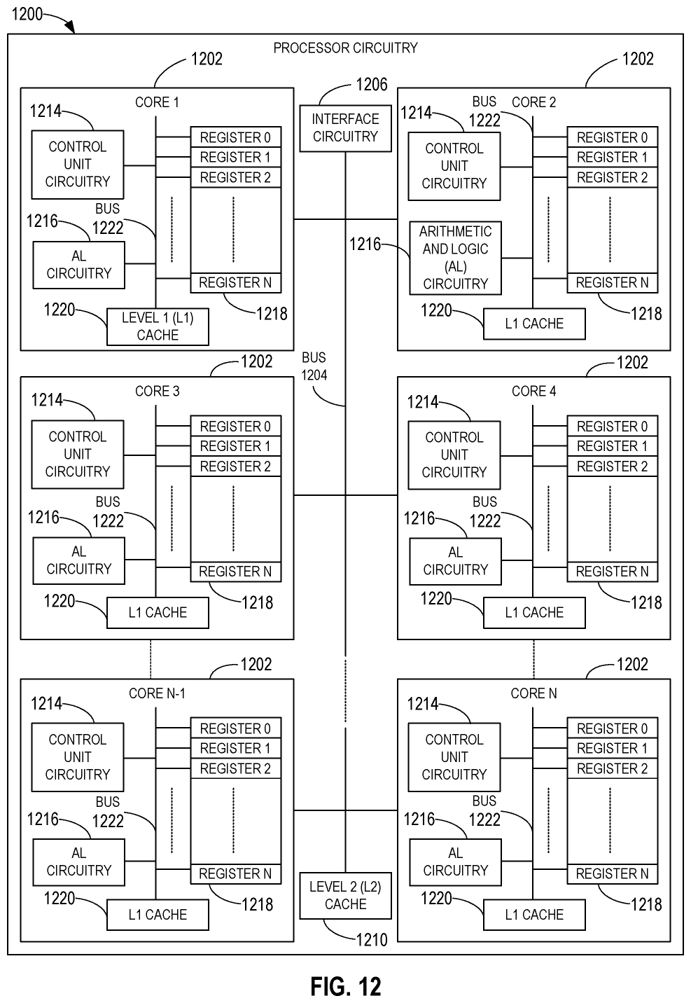

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general-purpose microprocessor (e.g., general purpose microprocessor circuitry). The microprocessor 1200 executes some or all of the machine-readable instructions of the flowcharts of FIGS. 8A-10 to effectively instantiate the cloud automation tool circuitry 110 of FIGS. 1, 2, 6, and 7 as logic circuits to perform the operations corresponding to those machine-readable instructions. In some such examples, the cloud automation tool 110 of FIG. 2 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 8A-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer-based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

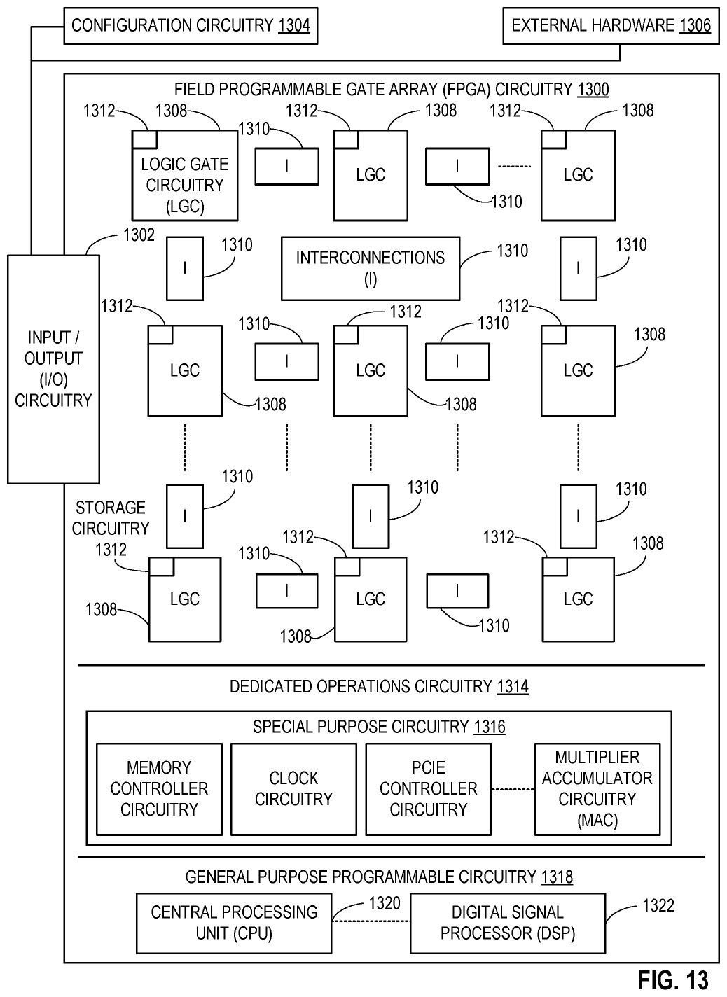

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the machine-readable instructions in hardware and, thus, can often execute the operations faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 8A-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 8A-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 8A-10. As such, the FPGA circuitry 1300 may be structured to effectively instantiate some or all of the machine-readable instructions of the flowcharts of FIGS. 8A-10 as dedicated logic circuits to perform the operations corresponding to those software instructions in a dedicated manner analogous to an ASIC. Therefore, the FPGA circuitry 1300 may perform the operations corresponding to the some or all of the machine-readable instructions of FIGS. 8A-10 faster than the general-purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine-readable instructions of FIGS. 8A-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 8A-10 may be executed by one or more of the cores 1202 of FIG. 12, a second portion of the machine readable instructions represented by the flowcharts of FIGS. 8A-10 may be executed by the FPGA circuitry 1300 of FIG. 13, and/or a third portion of the machine readable instructions represented by the flowcharts of FIGS. 8A-10 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

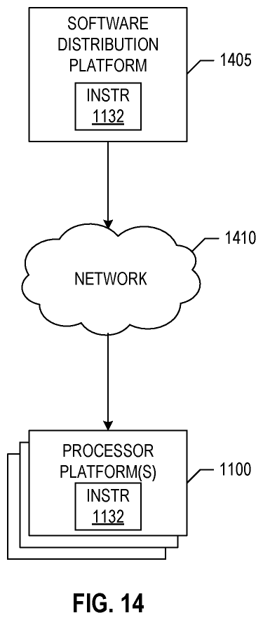

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine readable instructions 800 and/or 1000 of FIGS. 8A-10, as described above. The one or more servers of the example software distribution platform 1405 are in communication with an example network 1410, which may correspond to any one or more of the Internet and/or any of the example networks 1410 described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine readable instructions 800 and/or 1000 of FIGS. 8A-10, may be downloaded to the example processor platform 1100, which is to execute the machine readable instructions 1132 to implement the cloud automation tool 110 of FIGS. 1, 2, 6, and 7. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that allow the cloud automation tool 110 to manage non-native cloud deployments of custom resources. Disclosed systems, methods, apparatus, and articles of manufacture improve the efficiency of using a computing device by decreasing deployment complexity, management complexity, and orchestration complexity of cloud deployments that include both native cloud deployments and non-native cloud deployments. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to manage a cloud deployment are disclosed herein. Further examples and combinations thereof include the following.

Example 1 includes a system to manage a cloud deployment, the system comprising at least one memory, programmable circuitry, and machine readable instructions to cause the programmable circuitry to create a custom resource corresponding to the cloud deployment, the cloud deployment identifiable by cloud credentials of a cloud environment, the custom resource to include an action identifier, generate an infrastructure-as-data to represent the custom resource corresponding to the cloud deployment, the infrastructure-as-data to include the cloud credentials, and provide the infrastructure-as-data to an infrastructure adaptor, the infrastructure-as-data to cause performance of an operation corresponding to the action identifier using the cloud deployment.

Example 2 includes the system of example 1, wherein the programmable circuitry is to create the custom resource in a form service, the form service is a service of a cloud automation tool, the cloud automation tool to manage a cloud network by implementing an action to cause the infrastructure adaptor to manage the cloud deployment, the action identifiable by the action identifier.

Example 3 includes the system of example 1, wherein the programmable circuitry is to generate the infrastructure-as-data to cause the infrastructure adaptor to create a resource in the cloud environment based on the action identifier corresponding to a create operation, the infrastructure-as-data including a state to create the resource.

Example 4 includes the system of example 1, wherein the programmable circuitry is to generate the infrastructure-as-data to cause the infrastructure adaptor to delete a resource in the cloud environment based on the action identifier corresponding to a delete operation, the infrastructure-as-data including a state to delete the resource.

Example 5 includes the system of example 1, wherein the programmable circuitry is to generate the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

Example 6 includes the system of example 1, wherein the infrastructure-as-data is a first infrastructure-as-data, the programmable circuitry to generate the first infrastructure-as-data to cause the infrastructure adaptor to read the cloud deployment based on the action identifier corresponding to a read operation, receive a second infrastructure-as-data of the cloud deployment from the infrastructure adaptor, and update a schema of the custom resource based on the second infrastructure-as-data of the cloud deployment.

Example 7 includes the system of example 1, wherein the programmable circuitry is to include data specific to performance of an action in the infrastructure-as-data, the data specific to the performance of the action to cause the infrastructure adaptor to modify the cloud deployment, and the action identifiable by the action identifier.

Example 8 includes at least one non-transitory computer readable storage medium comprising instructions that, when executed, cause programmable circuitry to at least create a custom resource corresponding to a cloud deployment, the cloud deployment identifiable by cloud credentials of a cloud environment, the custom resource to include an action identifier, generate an infrastructure-as-data to represent the custom resource corresponding to the cloud deployment, the infrastructure-as-data to include the cloud credentials, and provide the infrastructure-as-data to an infrastructure adaptor, the infrastructure-as-data to cause performance of an operation corresponding to the action identifier using the cloud deployment.

Example 9 includes the at least one non-transitory computer readable storage medium of example 8, wherein the instructions are to cause the programmable circuitry to create the custom resource in a form service, the form service is a service of a cloud automation tool, the cloud automation tool to manage a cloud network by implementing an action to cause the infrastructure adaptor to manage the cloud deployment, the action identifiable by the action identifier.

Example 10 includes the at least one non-transitory computer readable storage medium of example 8, wherein the instructions are to cause the programmable circuitry to generate the infrastructure-as-data to cause the infrastructure adaptor to create a resource in the cloud environment based on the action identifier corresponding to a create operation, the infrastructure-as-data including a state to create the resource.

Example 11 includes the at least one non-transitory computer readable storage medium of example 8, wherein the instructions are to cause the programmable circuitry to generate the infrastructure-as-data to cause the infrastructure adaptor to delete a resource in the cloud environment based on the action identifier corresponding to a delete operation, the infrastructure-as-data including a state to delete the resource.

Example 12 includes the at least one non-transitory computer readable storage medium of example 8, wherein the instructions are to cause the programmable circuitry to generate the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

Example 13 includes the at least one non-transitory computer readable storage medium of example 8, wherein the infrastructure-as-data is a first infrastructure-as-data, the instructions to cause the programmable circuitry to generate the first infrastructure-as-data to cause the infrastructure adaptor to read the cloud deployment based on the action identifier corresponding to a read operation, receive a second infrastructure-as-data of the cloud deployment from the infrastructure adaptor, and update a schema of the custom resource based on the second infrastructure-as-data of the cloud deployment.

Example 14 includes the at least one non-transitory computer readable storage medium of example 8, wherein the instructions are to cause the programmable circuitry to include data specific to performance of an action in the infrastructure-as-data, the data specific to performance of the action to cause the infrastructure adaptor to modify the cloud deployment, the action identifiable by the action identifier.

Example 15 includes a method of managing a cloud deployment using a form service, the method comprising creating a custom resource corresponding to the cloud deployment, the cloud deployment identifiable by cloud credentials of a cloud environment, the custom resource to include an action identifier, generating an infrastructure-as-data to represent the custom resource corresponding to the cloud deployment, the infrastructure-as-data to include the cloud credentials, and providing the infrastructure-as-data to an infrastructure adaptor, the infrastructure-as-data to cause performance of an operation corresponding to the action identifier using the cloud deployment.

Example 16 includes the method of example 15, further including creating the custom resource in a form service, the form service is a service of a cloud automation tool, the cloud automation tool to manage a cloud network by implementing an action to cause the infrastructure adaptor to manage the cloud deployment, the action identifiable by the action identifier.

Example 17 includes the method of example 15, further including generating the infrastructure-as-data to cause the infrastructure adaptor to create a resource in the cloud environment based on the action identifier corresponding to a create operation, the infrastructure-as-data including a state to create the resource.

Example 18 includes the method of example 15, further including generating the infrastructure-as-data to cause the infrastructure adaptor to delete a resource in the cloud environment based on the action identifier corresponding to a delete operation, the infrastructure-as-data including a state to delete the resource.

Example 19 includes the method of example 15, further including generating the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

Example 20 includes the method of example 15, wherein the infrastructure-as-data is a first infrastructure-as-data, further including generating the first infrastructure-as-data to cause the infrastructure adaptor to read the cloud deployment based on the action identifier corresponding to a read operation, receiving a second infrastructure-as-data of the cloud deployment from the infrastructure adaptor, and updating a schema of the custom resource based on the second infrastructure-as-data of the cloud deployment.

Example 21 includes the method of example 15, further including data specific to performance of an action in the infrastructure-as-data, the data specific to performance of the action to cause the infrastructure adaptor to modify the cloud deployment, the action identifiable by the action identifier.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A system to manage a cloud deployment, the system comprising:
at least one memory;
programmable circuitry; and
machine readable instructions to cause the programmable circuitry to:
create a custom resource corresponding to the cloud deployment, the cloud deployment identifiable by cloud credentials of a cloud environment, the custom resource to include an action identifier;
generate an infrastructure-as-data to represent the custom resource corresponding to the cloud deployment, the infrastructure-as-data to include the cloud credentials; and
provide the infrastructure-as-data to an infrastructure adaptor, the infrastructure-as-data to cause performance of an operation corresponding to the action identifier using the cloud deployment.

2. The system of claim 1, wherein the programmable circuitry is to create the custom resource in a form service, the form service is a service of a cloud automation tool, the cloud automation tool to manage a cloud network by implementing an action to cause the infrastructure adaptor to manage the cloud deployment, the action identifiable by the action identifier.

3. The system of claim 1, wherein the programmable circuitry is to generate the infrastructure-as-data to cause the infrastructure adaptor to create a resource in the cloud environment based on the action identifier corresponding to a create operation, the infrastructure-as-data including a state to create the resource.

4. The system of claim 1, wherein the programmable circuitry is to generate the infrastructure-as-data to cause the infrastructure adaptor to delete a resource in the cloud environment based on the action identifier corresponding to a delete operation, the infrastructure-as-data including a state to delete the resource.

5. The system of claim 1, wherein the programmable circuitry is to generate the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

6. The system of claim 1, wherein the infrastructure-as-data is a first infrastructure-as-data, the programmable circuitry to:
generate the first infrastructure-as-data to cause the infrastructure adaptor to read the cloud deployment based on the action identifier corresponding to a read operation;
receive a second infrastructure-as-data of the cloud deployment from the infrastructure adaptor; and
update a schema of the custom resource based on the second infrastructure-as-data of the cloud deployment.

7. The system of claim 1, wherein the programmable circuitry is to include data specific to performance of an action in the infrastructure-as-data, the data specific to the performance of the action to cause the infrastructure adaptor to modify the cloud deployment, and the action identifiable by the action identifier.

8. At least one non-transitory computer readable storage medium comprising instructions that, when executed, cause programmable circuitry to at least:
create a custom resource corresponding to a cloud deployment, the cloud deployment identifiable by cloud credentials of a cloud environment, the custom resource to include an action identifier;
generate an infrastructure-as-data to represent the custom resource corresponding to the cloud deployment, the infrastructure-as-data to include the cloud credentials; and
provide the infrastructure-as-data to an infrastructure adaptor, the infrastructure-as-data to cause performance of an operation corresponding to the action identifier using the cloud deployment.

9. The at least one non-transitory computer readable storage medium of claim 8, wherein the instructions are to cause the programmable circuitry to create the custom resource in a form service, the form service is a service of a cloud automation tool, the cloud automation tool to manage a cloud network by implementing an action to cause the infrastructure adaptor to manage the cloud deployment, the action identifiable by the action identifier.

10. The at least one non-transitory computer readable storage medium of claim 8, wherein the instructions are to cause the programmable circuitry to generate the infrastructure-as-data to cause the infrastructure adaptor to create a resource in the cloud environment based on the action identifier corresponding to a create operation, the infrastructure-as-data including a state to create the resource.

11. The at least one non-transitory computer readable storage medium of claim 8, wherein the instructions are to cause the programmable circuitry to generate the infrastructure-as-data to cause the infrastructure adaptor to delete a resource in the cloud environment based on the action identifier corresponding to a delete operation, the infrastructure-as-data including a state to delete the resource.

12. The at least one non-transitory computer readable storage medium of claim 8, wherein the instructions are to cause the programmable circuitry to generate the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

13. The at least one non-transitory computer readable storage medium of claim 8, wherein the infrastructure-as-data is a first infrastructure-as-data, the instructions to cause the programmable circuitry to:
generate the first infrastructure-as-data to cause the infrastructure adaptor to read the cloud deployment based on the action identifier corresponding to a read operation;
receive a second infrastructure-as-data of the cloud deployment from the infrastructure adaptor; and
update a schema of the custom resource based on the second infrastructure-as-data of the cloud deployment.

14. The at least one non-transitory computer readable storage medium of claim 8, wherein the instructions are to cause the programmable circuitry to include data specific to performance of an action in the infrastructure-as-data, the data specific to performance of the action to cause the infrastructure adaptor to modify the cloud deployment, the action identifiable by the action identifier.

15. A method of managing a cloud deployment using a form service, the method comprising:
creating a custom resource corresponding to the cloud deployment, the cloud deployment identifiable by cloud credentials of a cloud environment, the custom resource to include an action identifier;
generating an infrastructure-as-data to represent the custom resource corresponding to the cloud deployment, the infrastructure-as-data to include the cloud credentials; and
providing the infrastructure-as-data to an infrastructure adaptor, the infrastructure-as-data to cause performance of an operation corresponding to the action identifier using the cloud deployment.

16. The method of claim 15, further including creating the custom resource in a form service, the form service is a service of a cloud automation tool, the cloud automation tool to manage a cloud network by implementing an action to cause the infrastructure adaptor to manage the cloud deployment, the action identifiable by the action identifier.

17. The method of claim 15, further including generating the infrastructure-as-data to cause the infrastructure adaptor to create a resource in the cloud environment based on the action identifier corresponding to a create operation, the infrastructure-as-data including a state to create the resource.

18. The method of claim 15, further including generating the infrastructure-as-data to cause the infrastructure adaptor to delete a resource in the cloud environment based on the action identifier corresponding to a delete operation, the infrastructure-as-data including a state to delete the resource.

19. The method of claim 15, further including generating the infrastructure-as-data to include a schema of the custom resource, the schema to cause the infrastructure adaptor to update the cloud deployment based on the action identifier corresponding to an update operation, the infrastructure-as-data including a state of a property of the schema to update the property.

20. The method of claim 15, wherein the infrastructure-as-data is a first infrastructure-as-data, further including:
generating the first infrastructure-as-data to cause the infrastructure adaptor to read the cloud deployment based on the action identifier corresponding to a read operation;
receiving a second infrastructure-as-data of the cloud deployment from the infrastructure adaptor; and
updating a schema of the custom resource based on the second infrastructure-as-data of the cloud deployment.

21. The method of claim 15, further including data specific to performance of an action in the infrastructure-as-data, the data specific to performance of the action to cause the infrastructure adaptor to modify the cloud deployment, the action identifiable by the action identifier.
